(19) United States
(12) Patent Application Publication
(10) Pub. No.: US 2021/0029112 A1
(43) Pub. Date: Jan. 28, 2021

(54) TAPTIC AUTHENTICATION SYSTEM AND METHOD

(71) Applicant: Wells Fargo Bank, N.A., San Francisco, CA (US)

(72) Inventors: Naveen Saichand Palle, Hyderabad (IN); Rameshchandra Bhaskar Ketharaju, Hyderabad (IN)

(21) Appl. No.: 15/251,419

(22) Filed: Aug. 30, 2016

(51) Int. Cl. H04L 29/06; G06F 17/30

(52) U.S. Cl. CPC H04L 63/0861; H04L 63/0853; G06F 17/30312; H04L 63/102; H04L 63/123; H04L 63/06

(57) ABSTRACT

The innovation disclosed and claimed herein, in one aspect thereof, comprises systems and methods of authenticating customers of a financial institution. Authentication includes the system and method receiving taptic patterns made up of taps or movements. The taptic patterns are compared against a stored taptic pattern for a match. Authentication includes a biometric confirmation of the customer's identity. The biometric and taptic patterns can be recorded using a variety of integrated device embodiments.

### BACKGROUND

Customers using automated teller machines (ATMs) are sometimes targets of robberies and other crimes. Customers should take care to guard the ATM screen from other people. Further, the customers may have to block the keypad so that the ATM screen and key presses are masked. Customers may lose control of their accounts and their login credentials through card skimmers that read the magnetic stripe from bank cards and even record the input of their PIN (Personal Identification Number) numbers. Similarly, there may be a risk of losing customer login credentials when the user logs into a mobile application using a mobile device or wearable device at a public location. Likewise, increased risk exists when the customer types a password at a point of sale (POS) device to authenticate a transaction. Some hackers can observe the password or the transaction details using hidden cameras or any other advanced screen readers. Hackers have developed intricate and hidden schemes to watch the customer keystrokes with various means.

### BRIEF SUMMARY OF THE DESCRIPTION

The following presents a simplified summary of the innovation in order to provide a basic understanding of some aspects of the innovation. This summary is not an extensive overview of the innovation. This brief summary is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of authenticating users. A customer, e.g. a general banking customer, may be authenticated. Authentication can includes verifying the identity of the customer that is known as a trusted customer, before consummation of a financial transaction.

The methods and systems of the present innovation relates to securely transacting with ATMs, mobile devices, wearable devices, POS's and/or kiosks. More particularly, the system and method is related to inputting transaction details, passwords, customer information, and/or the like. ATM, mobile devices, internet of things (IOT) devices, POS/Kiosk, and internet connected computers are financial service institution transaction client devices. These devices communicate over financial service (FS) servers in identifying and authenticating the device and the customer, and help the customer start and complete a financial transaction securely. The methods and systems can include one or more IOT devices coupled with FS systems and devices. At least one of the IOT devices can include components configured to determine or analyze biometric data, a set of pre-configured and customized taptic patterns, a continuous learning of taptic patterns, and/or the like. The customer may be authenticated and transact with the FS servers using one or more of: biometric details of the customer and the taptic pattern.

In an exemplary embodiment of the innovation, a system for authenticating a customer is disclosed. The system includes a device having a biometric reader that receives biometric data from the customer and a taptic receiver that receives a taptic pattern provided by the customer. The system further includes an identity access management system having an identity access management database that stores recorded biometric data and a recorded taptic pattern associated with a customer. The identity access management system includes a validation engine that matches the received biometric data to the recorded biometric data and the recognized taptic pattern to the recorded taptic pattern, wherein the customer is authenticated upon determining the recorded biometric data and recorded taptic pattern match the received biometric data and recognized taptic pattern respectively.

In another exemplary embodiment, a method for authenticating a customer is disclosed. The method includes recording a first taptic pattern provided by a customer when registering the customer at a validation engine; and storing the taptic pattern in an identity access management database. The method includes receiving a second taptic pattern from a remote authentication device and comparing the second taptic pattern to the first taptic pattern. The method authenticates the customer upon determining the second taptic pattern matches the first taptic pattern.

In various aspects, the subject innovation provides substantial benefits in terms of authentication and transactional security. One advantage resides in a more secure knowledge of the identity of a customer. Another advantage resides in the lack of need for a traditional password to authenticate a customer.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a system for registering a customer.

FIG. 2 illustrates example system diagram of an authentication system.

FIG. 3A illustrates an example diagram of an integrated device.

FIG. 3B illustrates an example diagram of an integrated device.

FIG. 4 illustrates an example embodiment of a mobile device application with taptic authentication.

FIG. 5 illustrates a flowchart for registering a customer of a financial institution.

FIG. 6 illustrates a flowchart for authenticating a customer of a financial institution.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

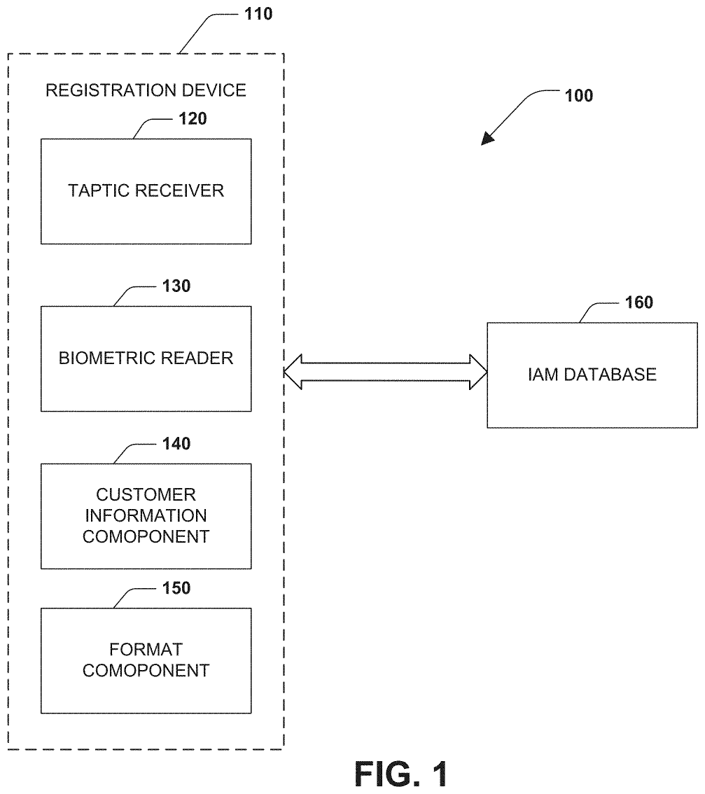

FIG. 1 shows a system 100 for registering a customer to create an account. As an initial step, a customer, e.g. a person creating or altering an account with a financial institution, provides information about themselves to the financial institution to facilitate identifying the customer before or during future financial transactions. A registration device 110 collects the information. The registration device 110 includes inputs for recording and/or receiving information about the customer or provided by the customer.

The registration device 110 includes a biometric reader 120. The biometric reader 120 can obtain variety of different types of biometric data from the customer. For example, the biometric reader 120 can obtain one or more of fingerprints, palm vein data, other vein data, facial recognition data, gait analysis data, retina or iris data, and/or the like. In some embodiments, the biometric reader 120 includes a membrane that can read veins when in contact by the customer. In various embodiments, each type of biometric data is recorded of the customer such that the customer can input and the system 100 can receive different biometric data during future authentications.

The registration device 110 includes a taptic receiver 130. The taptic receiver 130 can receive a taptic pattern created by the customer. The taptic pattern is a pattern represented by taps or movements by the customer in a distinct pattern or rhythm. In some embodiments, the taptic pattern can be input on a taptic membrane configured to receive taps, haptic input, and/or taptic patterns. Further embodiments of a taptic receiver 130 will be discussed in detail below.

The registration device 110 includes a customer information component 140. The customer information component 140 is configured to receive other information about the customer. For example, other information can include name, account number, social security number, a PIN, date of birth, age, security questions, and/or the like. The customer information component 140 can be received via a keyboard, mouse, and/or monitor. In another embodiment, the customer information component 140 can migrate information from various data sources that can provide customer information such as old or canceled accounts, and/or the like.

The registration device 110 includes a format component 150. The format component 150 receives the taptic pattern, biometric data, and customer information. The format component 150 converts the received data into a format for storage in an identity access management (IAM) database 160. For example, the format component 150 can convert the taps and haptic input in the taptic pattern into a text string representing the taptic pattern. In this embodiment, the taptic pattern can be divided into sequences. In one embodiment, sequences are devised from pauses within the taptic pattern. A special character can separate the sequences in the text string. For example, a % character can indicate the first sequence of the taptic pattern. A full taptic pattern can be represented as %I@IIII#II$II. Where ‘I’ represents a single tap, “II” represents two taps, and so forth. The upper limit can be extended based on the user experience or financial institution requirements and/or preferences. The number of taps for each sequence in the taptic pattern varies from one to four or any number of patterns. In this particular example upper limit set as four. The special characters %, @ #, $ represent the start of the first, second, third, and fourth sequence of the taptic pattern.

The biometric data, taptic pattern, and/or the customer information can be stored in the IAM database 160. A database entry in the IAM database 160 can be represented as shown below if Table 1.

TABLE 1

| | Palm | Palm | Palm | Palm | Palm | Palm | |
|---|---|---|---|---|---|---|---|
| | Vein | Vein | Vein | Vein | Vein | Vein | |
| | Image | Image | Image | Image | Image | Image | |
| User Account | Left | right | Left | right | Left | right | |
| Number | Hand-I | hand-I | Hand-II | hand-II | Hand-n | hand-n | Taptic Pattern |
| AA1234BB567 | L- | R- | L- | R- | L- | R- | % I @ IIII #II$II |
| | Image-1 | Image-1 | Image-2 | Image-2 | Image-n | Image-n | |

As shown in Table 1 above, the customer is represented as a user account number associated with the customer's account with the financial institution and/or the like. The biometric data is stored as palm vein images of different veins in the right and left hands of the customer. The taptic pattern is represented as a text string as described above. In one embodiment, the format component 150 generates an encrypted key based on the taptic pattern and/or the biometric data. The key can then be stored in the IAM database 160 and associated with the customer account.

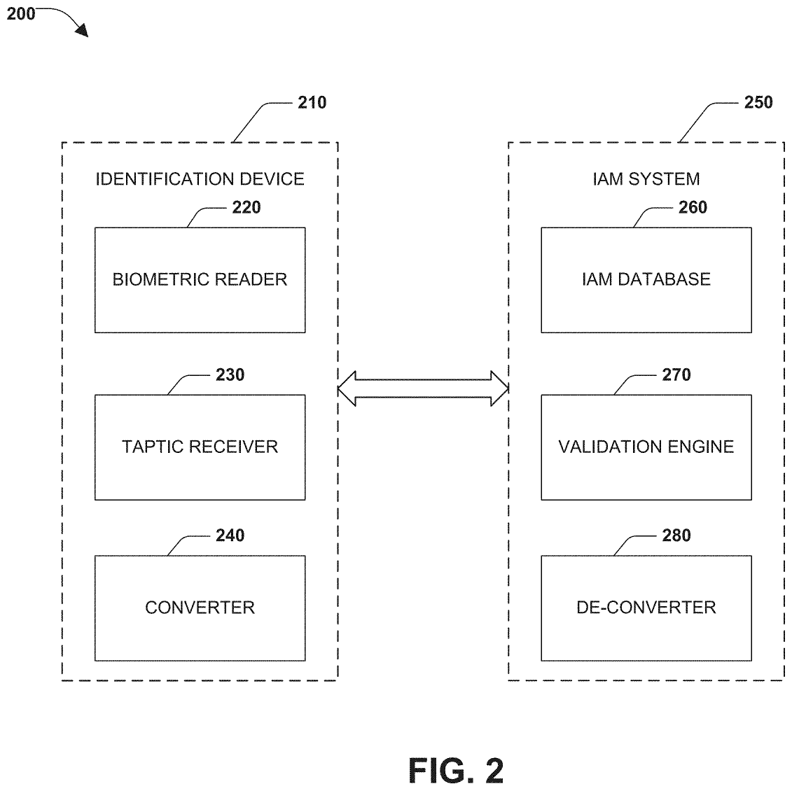

FIG. 2 is an example system diagram of an authentication system 200. The authentication system 200 includes an identification device 210. The identification device 210 can be a remote system for conducting financial transactions or other actions where a valid authentication of a customer identity is desired. For example, the identification device 210 may be an ATM, a mobile device, and/or the like. The identification device 210 may be a separate internet of things (IOT) device that can connect to an ATM, a financial institution computer/network/system, and/or the like.

The identification device 210 includes a biometric reader 220. The biometric reader 220 can read physical characteristics, i.e. biometrics, of a customer that are unique only to the customer to facilitate identification and/or authentication. The biometric reader 120 can obtain a variety of different biometrics from the customer. For example, the biometric reader 120 can obtain one or more of fingerprints, palm vein data, other vein data, facial recognition data, gait analysis data, retina or iris data, and/or the like. In some embodiments, the biometric reader 220 continuously reads the biometric data of the customer from the initiation of the financial transaction to the end of the financial transaction to confirm the customer's identity during the entire time the customer is conducting the financial transaction. In these embodiments, authentication and/or the financial transaction is canceled if the biometric reader 220 is no longer confirming the customer's identity. In various embodiments, the biometric reader 220 may query for biometric data at known or random intervals or varying intervals during a financial transaction and cancel or prompt the customer to provide biometric input to continue the transaction. Responsive to determining that the biometric data does not belong to the customer that initiated the transaction, the system 100 may cancel the transaction.

In one embodiment, the biometric reader 220 includes a camera. The camera can capture a photograph or video data of the customer. The photograph and/or video data can be used with facial recognition algorithms to confirm the identity of the customer whose facial data was recorded during registration. In another embodiment, the camera can capture iris data of the customer. The iris data can be used by iris recognition algorithms to confirm the identity of the customer whose iris data has been recorded during registration.

The identification device 210 includes a taptic receiver 230. The taptic receiver 230 can receive a taptic pattern created by the customer. The taptic pattern is a pattern represented by taps, pressure, or movements by the customer in a distinct pattern or rhythm. In various embodiments, the taptic pattern can be input on a taptic membrane configured to receive taps and/or taptic patterns. The taptic receiver 230 is discussed in detail below.

The identification device 210 includes a converter 240. The converter 240 formats the taptic pattern received by the taptic receiver 230 and/or data received by the biometric reader 220. The converter 240 can encrypt the data for transmission over a server such that the data is protected while being transmitted.

The authentication system 200 includes an identity access management (IAM) system 250. The IAM system 250 can be a part of a larger network belonging to a financial institution or a standalone system. The IAM system 250 communicates with the identification device 210 to send and receive data such as customer information, biometric data, and taptic pattern data. The IAM system 250 includes an IAM database 260. The IAM database 260 includes customer information, recorded customer biometrics, and recorded taptic patterns associated with the customer's account. The IAM database 260 can include further customer account information or receive customer account information from other databases of a financial institution.

The IAM system 250 includes a validation engine 270. The validation engine 270 includes processors and/or the like to confirm the identity of the customer. The validation engine 270 receives biometric data and/or a taptic pattern from the identification device 210. The validation engine 270 can also receive customer information from the identification device 210. The validation engine 270 can use the customer information, such as an account number, to retrieve the database record associated with the customer information from the IAM database 260. The validation engine 270 checks the received biometric data and/or the taptic pattern against the stored biometric data and/or taptic pattern in the database record. For example, a customer wishing to make an ATM withdrawal provides identifying information and/or data at the ATM, the validation engine 270 matches the provided data to the data stored in the IAM database 260 to confirm the identity of the customer. In one embodiment, the validation engine 270 includes an error metric which provides a minimum threshold with which to compare the taptic pattern to the recorded taptic pattern. This ensures that when the customer input has some variance, albeit small, with which to tap the taptic pattern the customer is authenticated.

If the the validation engine 270 determines the biometric data and/or the taptic patterns match, the validation engine 270 can generate an authentication response token. The validation engine 270 can return the authentication response token to the identification device 210 which allows the customer to proceed with the financial transaction.

The IAM system 250 can include a de-converter 280. In the case that the biometric data and/or the taptic pattern is encrypted by the converter 240, the de-converter 280 can unencrypt the biometric data and/or the taptic pattern. The de-converter 280 can pass the unecrypted data to the the validation engine 270 for processing as described above.

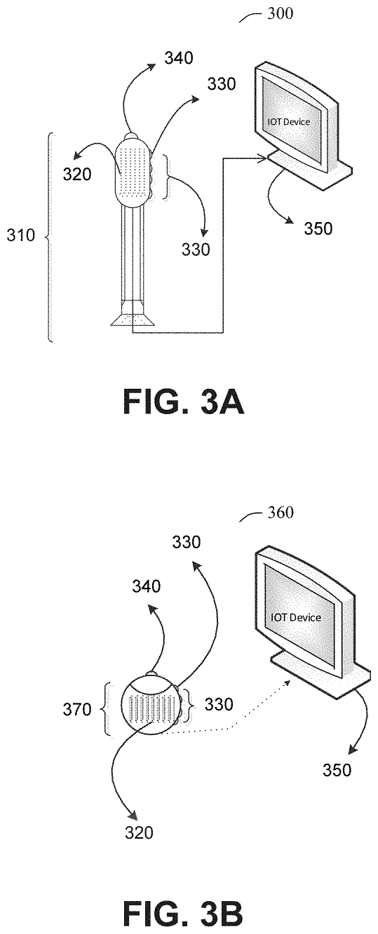

In some embodiments, a biometric reader and a taptic receiver integrated into an integrated device. For example, with reference to FIG. 3A, an example diagram of an integrated device 300 is depicted. The integrated device 300 includes a bar 310 with a palm vein reader 320. The bar 310 can be shaped such that it includes a provision for the customer to hold the bar 310 sufficient contact to receive biometric input. The provision can include grooves to insert four or five fingers and hold the bar 310. The palm vein reader 320 can read arteries in the palm of a customer's hand such that they can be recorded and matched to recorded vein data.

The bar 310 includes embedded buttons 330. A customer can input a taptic pattern using one or more of the embedded buttons 330. The embedded buttons 330 may include one or more types of button panels. The embedded buttons 330 can be positioned on the rear side of the bar 310 such that a person behind the customer cannot visually steal or record the taptic pattern when input is received by the customer. The embedded buttons 330 can include just a single button panel or can include four buttons located at four fingers except thumb finger. The four buttons can be designated for each sequence of the taptic pattern such that the first sequence is input by the index finger, the second sequence is input by the middle finger, and so forth. In another embodiment, the embedded buttons 330 can include four buttons with a navigation ball 340 at the thumb finger.

In another embodiment, embedded buttons 330 can read finger movement and/or taps using simple touch. In yet another embodiment the embedded buttons 330 can read finger movement using one or more tiny cameras embedded in the bar 310 and/or in the environment surround the bar 310 and/or integrated device 300.

The bar 310 is connected to an IOT monitor 350. The IOT monitor 350 can provide a graphical user interface (GUI) to the customer. The customer can read prompts or other data or instructions on the IOT monitor 350. The customer can use the bar 310 to navigate through menus or options.

With reference to FIG. 3B, another example diagram of an integrated device 360 is depicted. The integrated device 360 includes a ball 370 with palm vein reader 320. The ball 370 can be shaped such that is includes a provision for the customer to hold the ball 370 properly. The provision can include grooves to insert five fingers and hold the ball 370. The palm vein reader 320 can read blood vessel patterns, veins, and/or arteries in the palm of a customer's hand such that they can be recoreded and matched to recorded vein data.

The ball 370 includes embedded buttons 330. A customer can input a taptic pattern using one or more of the embedded buttons 330. The embedded buttons 330 may include one or more types of button panels. The embedded buttons 330 can be positioned on the rear side the ball 370 such that a person behind the customer cannot visually steal or record the taptic pattern when input by the customer. The embedded buttons 330 can include just a single button panel or can include four buttons located at four fingers except thumb finger. The four buttons can be designated for each sequence of the taptic pattern such that the first sequence is input by the index finger, the second sequence is input by the middle finger, and so forth. In another embodiment, the embedded buttons 330 can include four buttons with a navigation ball 340 at the thumb finger.

In another embodiment, embedded buttons 330 can read finger movement and/or taps using simple touch. In yet another embodiment the embedded buttons 330 can read finger movement using one or more tiny cameras embedded in the ball 370 and/or in the environment surround the ball 370 and/or integrated device 300.

The ball 370 is connected to an IOT monitor 350. The IOT monitor 350 can provide a graphical user interface (GUI) to the customer. The customer can read prompts or other data or instructions on the IOT monitor 350. The customer can use the ball 370 to navigate through menus or options.

In one embodiment, the customer may be provided with an enhanced GUI and physical user interface. For example, embedded buttons may be utilized for other operations. In this example, the customer's username may be auto-filled after recognizing the customer by a smart user identification method. The customer can input taptic pattern using the embedded buttons as described above. The IOT monitor 350 may go blank when customer taps the taptic pattern. When the customer taps with the embedded button(s), they may not notice how many taps has occurred. To help the customer, a sense object can be created for each tap on an embedded button appearing for a predeterming time period, so that customer can sense the number of taps. The sense objects, e.g. physical bubbles or small pipes, can pop up dynamically on the tapped embedded button with number of taps so the customer can feel how many taps have been input. The sense objects can disappear in a few seconds.

The enhanced GUI can include a time lag. The time lag can tab the cursor to a next sequence of the taptic pattern or select a different criteria to input such as denomination. For example, the customer can use the embedded buttons to input a denomination for cash to withdraw from an ATM. The customer can tap the denomination values or hold the embedded buttons to increas the denomination. For example, the customer can press and hold the embedded button causing the denomination numbers to move continuously with a time lag. The customer can release the button once desired number is reached. Alternatively, consecutive taps can be tapped with each tap having a standardized value. The customer can tap on the embedded button until the desired number is reached. In another embodiment, the customer can utilize multiple embedded buttons, with each embedded button corresponding to a number position in the denomination. For example, using thumb finger button for 10 thousand position, pointer finger button for thousands position, middle finger for 100th position, and so forth. Each tap increases the value in the position by 1.

In another embodiment, the integrated device is a customer ATM card or a separate card that the customer can easily carry on their person. The ATM card can have a membrane to read veins in the hand of the customer. The ATM card can include a taptic membrane to receive taptic pattern. The ATM card can conncect to an ATM when the customer is in proximity of the ATM or can wirelessly connect to a customer mobile device.

In another embodiment, the integrated device 300 can read finger movements using the combination of other IOT devices as part of the fingers, hand or wrist. The IOT devices can wirelessly connect to a financial institution server or to an ATM or another authentication device, e.g. a mobile device, to relay data. For example, an IOT ring worn on a customer's finger. The IOT ring can read the veins in the ringed finger for biometric data and include buttons around the ring to receive taptic patterns from the customer. In another example, the integrated device can be IOT wearable glasses. The IOT wearable glasses can read veins near the temple of a head, behind the ears, and/or any other parts of the customer's body where the IOT wearable glasses contacts the customer. The IOT wearable glasses can read blinking patterns of the eyes to receive a taptic pattern. In another example, the integrated device can be an IOT squeeze ball. The IOT squeeze ball can read palm veins or any other parts of the body where the IOT squeeze ball contacts. The IOT squeeze ball can include buttons to receive taptic patterns. In another example, the integrated device is IOT footwear. The IOT footwear can include a vein reader membrane. The IOT footwear can include a touch pad could be atcould be at toe or at heel to read taptic patterns with toe taps and/or heel taps. In another example, the integrated device are IOT gloves. The IOT gloves can include a vein reader membrane. The IOT gloves can include a motion sensor that can read taptic patterns made by finger movements.

In another embodiment, the integrated device is a touch screen on an ATM. A biometric reader can read the entire palm vein. The touch screen can receive taptic patterns. In another embodiment, physical or graphical ATM buttons can receive the taptic patterns. For example, the customer can input the taptic pattern on the numeric keypad typically used for ATMs. In this embodiment, further security features can be applied. Such as, a customer can request an authentication code through a financial institution registered mobile device or wearable device. The customer will receive a unique single digit taptic pass code to his/her registered device, e.g. mobile device or wearable device). For example, the single digit pass code can be “7.” The customer can operate the ATM for a transaction where the customer will be prompted to enter a taptic pattern for authenticaton. The customer will tap the taptic pattern using only the number “7” on the numeric keypad.

In another embodiment of this example, the customer is provided with a series of numbers or sequences of the keypad to enter different sequences of the taptic pattern. For example, the customer can be provided with a passcode “1234” for which the customer taps the first sequence of the taptic pattern on “1,” the second sequence on “2,” and so forth. Alternatively, the passcode for each sequence is standardized or the passcode can correspond to the customer's private registered PIN.

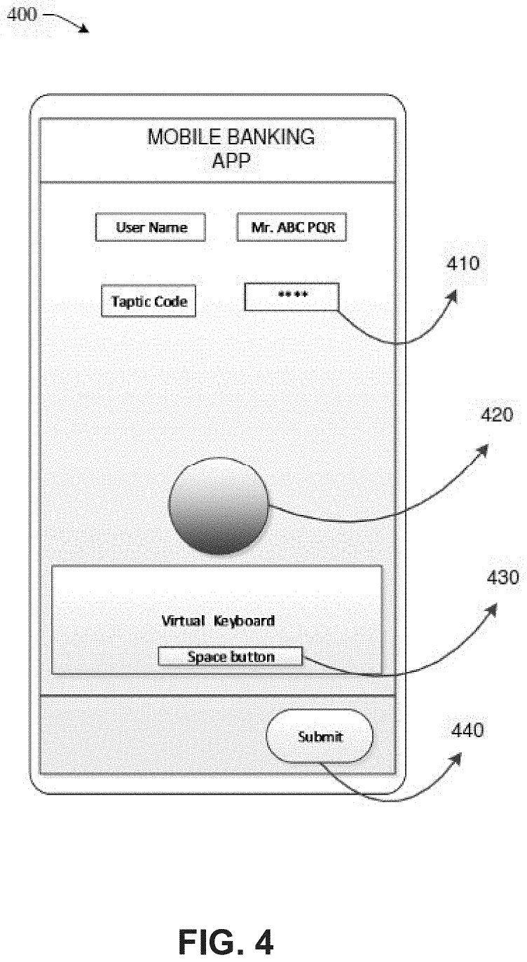

With reference to FIG. 4, an example embodiment of a mobile device application with taptic authentication is depicted. The customer can download and install a mobile banking application to a mobile device having a processor and a memory. The customer can run the mobile banking application on the mobile device. The mobile banking application can access and connect to financial institution servers and/or systems to complete transactions. The customer is then prompted to input authentication credentials to access their customer account through th mobile device. The customer selects the authentication place holder 410 which activates the application to receive a taptic pattern. The customer provides a taptic pattern using the taptic button 420 or area of the screen of the mobile device. In an alternative embodiment, the customer is directed to tap a specified key in a virtual keyboard 430 presented to the customer within the application. For example, the customer can be prompted to input the taptic pattern by tapping on the spacebar of the virtual keyboard. The customer will tap the same button multiple times with a time lag will creates a pattern. In other embodiments, the customer taps different keys for different sequences of the taptic pattern. In addition, a biometric reader can be implemented in the mobile device to read a customer's biometrics.

The mobile device can convert the taptic pattern into an 128-bit encrypted key. The mobile device sends the key to a validation engine located in the financial institution system or IAM system of the financial instution. A decryption utility in the IAM system decrypts the 128 bit encrypted key and passes the unecrypted data within the key to the validation engine. The validation engine matches the taptic pattern to a recorded taptic pattern associated with customer in an IAM database of the IAM system. The validation engine sends response token to complete the transaction if it matches the configured pattern.

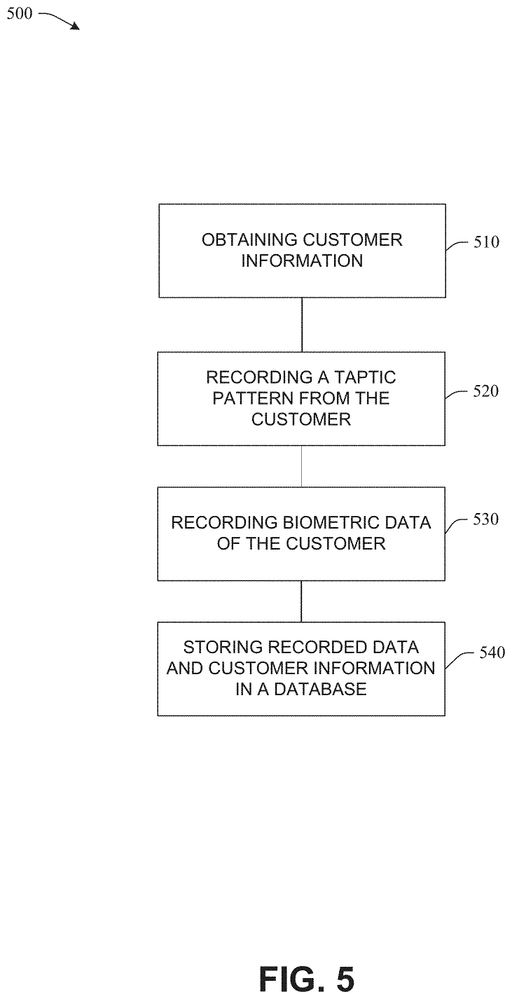

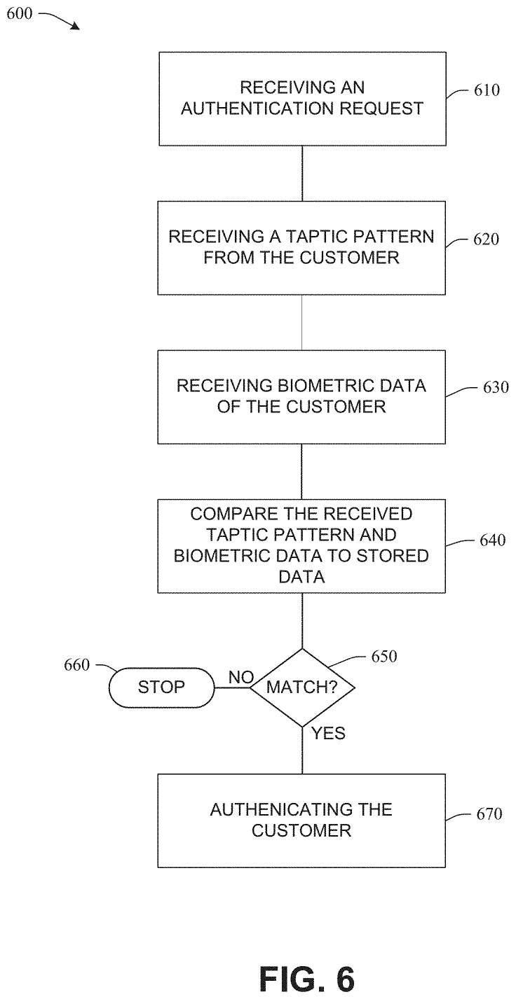

With reference to FIG. 5 and FIG. 6, example methods are depicted for registering and authenticating a customer of a financial institution. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 500 is described in conjunction with a specific example is for explanation purposes.

In aspects, a registration method 500 can begin at 510 by obtaining customer information. For example, a customer opens a new account at a financial institution. The customer provides typical identifying information such as name, address, social security number, date of birth, and/or the like. In one embodiment, a customer account number can be generated for the customer. At 520, the customer is prompted to provide a taptic pattern of their choosing. For example, the customer can tap a taptic pattern of a familiar rhythm that they can easily remember. In an alternate embodiment, the customer is provided a taptic pattern for which to memorize for future authentications. At 530, the customer is prompted to provide biometric data. For example, the customer can provide palm vein biometric data via a palm reader. At 540, the customer information, the taptic pattern, and the biometric data are stored in a database. For example, the data is input via a computer at a financial institution branch or where the data is collected and sent remotely for storage in a remote database. The database is accessible over mobile networks or traditional networks such that the data can be recalled at a future date when the customer is to be identified and/or authenticated.

With reference to FIG. 6, an authentication method 600 is depicted for authentication of a registered customer for a transaction. At 610, a financial institution receives an authentication request. For example, a customer commences a transaction at an ATM. The ATM forwards an authentication request to the financial institution to authenticate the customer. At 620, the customer provides a taptic pattern to the financial institution. In the example, the customer provides the taptic pattern using a bar attached to the ATM. At 630, the customer provides a biometric to the financial institution. In the example, the biometric data can provide a palm vein biometric using a palm vein reader on the bar attached to the ATM.

At 640, the taptic pattern and the biometric data are compared to a stored taptic pattern and stored biometric data associated with the customer's account. In the example, the customer provided taptic pattern and palm vein image are compared to stored taptic pattern and palm vein image that the customer previously provided upon registration. At 650, if the taptic patterns and biometric data do not match, the method stops at 660. At 650, if the taptic patterns and biometric do match, the customer is authenticated 670 to proceed with the financial transaction. In the example, if the customer provides the wrong taptic pattern, the customer cannot be authenticated and the transaction and/or ATM session is terminated. Alternatively, the customer may be prompted to re-input a taptic pattern that will match the stored taptic pattern associated with the account. If the customer provides a matching taptic pattern and biometric data, the customer is authenticated and can proceed with an ATM withdrawal or other financial transaction.

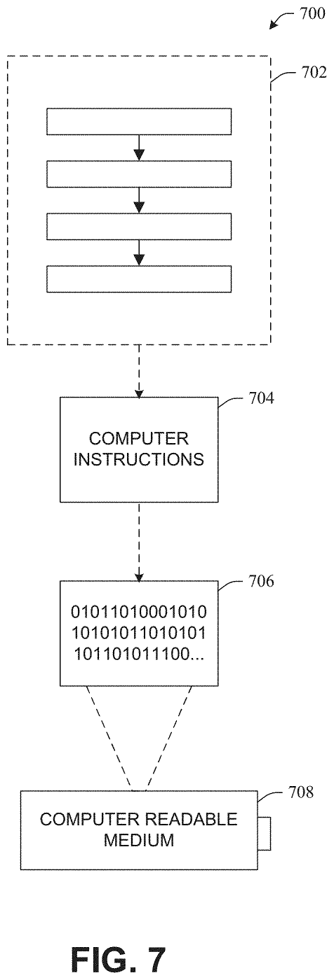

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable computer instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

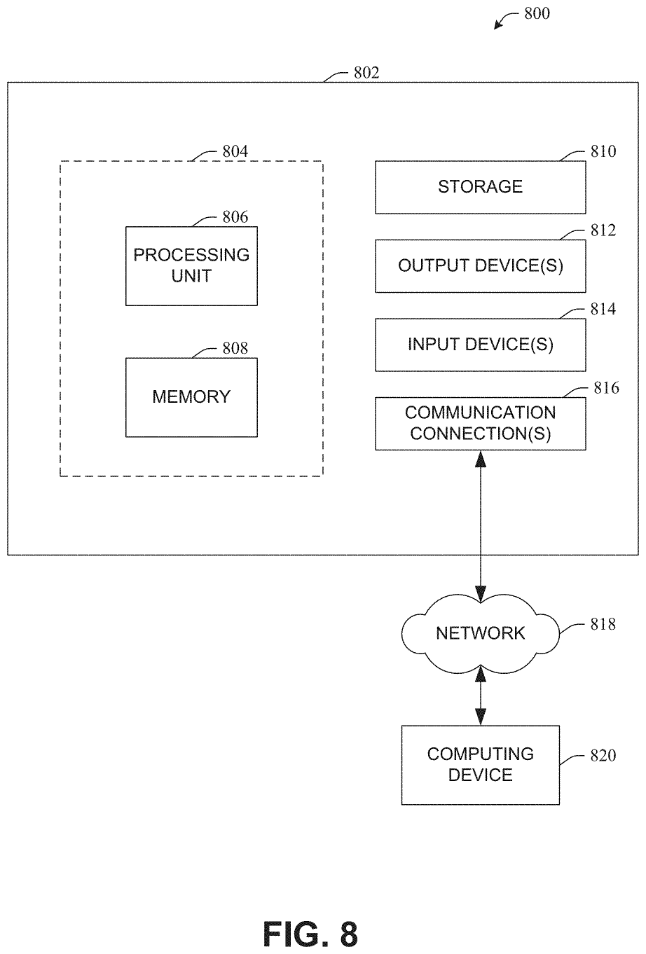

With reference to FIG. 8 and the following discussion provide a description of a suitable computing environment in which embodiments of one or more of the provisions set forth herein can be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 8 illustrates a system 800 comprising a computing device 802 configured to implement one or more embodiments provided herein. In one configuration, computing device 802 can include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 can include additional features or functionality. For example, device 802 can also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 can also store other computer readable instructions to implement an operating system, an application program, and the like. Computer readable instructions can be accessed in memory 808 for execution by processing unit 806, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media can be part of device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 802 can include one or more input devices 814 such as keyboard, mouse, pen, voice input device, touch input device, infrared cameras, video input devices, or any other input device. One or more output devices 812 such as one or more displays, speakers, printers, or any other output device can also be included in device 802. The one or more input devices 814 and/or one or more output devices 812 can be connected to device 802 via a wired connection, wireless connection, or any combination thereof. In some embodiments, one or more input devices or output devices from another computing device can be used as input device(s) 814 or output device(s) 812 for computing device 802. Device 802 can also include one or more communication connections 816 that can facilitate communications with one or more other devices 820 by means of a communications network 818, which can be wired, wireless, or any combination thereof, and can include ad hoc networks, intranets, the Internet, or substantially any other communications network that can allow device 802 to communicate with at least one other computing device 820.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An authentication system, comprising:
a device, comprising:
a biometric reader that receives biometric data; and
a taptic receiver that receives an input corresponding to a taptic pattern; and
an identity access management system, comprising:
an identity access management database that stores recorded biometric data and a recorded taptic pattern; and
a validation engine, implemented using at least one hardware processor, that matches the received biometric data to the recorded biometric data and the received taptic pattern to the recorded taptic pattern, and generates an authentication signal in response to determining the recorded biometric data and recorded taptic pattern match the received biometric data and received input respectively,
wherein the biometric reader continuously reads the biometric data of a customer from the initiation of the financial transaction to the end of the financial transaction to confirm the identity throughout the duration of the transaction and the financial transaction is canceled if the biometric reader is not confirming the identity of the customer,
wherein at least one processor within the system is dedicated to the continuous learning of taptic patterns, and
wherein the validation engine converts taps and haptic input in the taptic pattern into a string of text representing the taptic pattern.

2. The system of claim 1, wherein the taptic pattern is divided into sequences and wherein the system receives each sequence of the recorded taptic pattern from a customer via the taptic receiver.

3. The system of claim 2, wherein the biometric reader and the taptic receiver are integrated into a single device having embedded buttons having sense objects which appear for a predetermined time period to sense the number of taps, and wherein the taptic receiver includes designated finger positions for each sequence of the recorded taptic pattern.

4. The system of claim 1, wherein the taptic receiver is at least one of a joystick, a bank card, a squeeze ball, a ring, wearable glasses, a smart watch, footwear, or a glove.

5. The system of claim 1, wherein the input corresponding to the taptic pattern is received via at least one of finger taps, toe taps, eye blinks, or finger movements.

6. The system of claim 1, wherein the taptic receiver receives the input corresponding to the taptic pattern via a membrane.

7. The system of claim 1, further comprising:
a converter, implemented using at least one hardware processor, that encrypts the taptic pattern into a 128 bit encrypted key.

8. The system of claim 1, wherein the biometric reader authenticates the biometric data during a transaction and cancels the transaction if the biometric data does not match, wherein the biometric reader comprises IOT wearable glasses operative to read veins near a temple or behind an ear, wherein the IOT wearable glasses read blinking patterns of the eyes to receive a taptic pattern.

9. The system of claim 1, wherein the device further comprises:
a bar that reads biometric data from a customer when the bar is gripped and receives the taptic pattern input from at least one button that is activated by a finger of the customer.

10. The system of claim 1, further comprising:
wherein the validation engine transmits a response token to the device when the biometric data and the taptic pattern match the received biometric data and received taptic pattern respectively.

11. The system of claim 1, wherein the device is a mobile device operative to complete taptic authentication via a virtual keyboard, wherein the virtual keyboard is available as a software application for download by the mobile device.

12. An authentication method, comprising:
recording a taptic pattern, the taptic pattern containing haptic input, when registering at a validation engine;
storing the taptic pattern in an identity access management database;
receiving, via a taptic membrane configured to receive taps, haptic input, and taptic patterns, an input corresponding to the taptic pattern from a remote authentication device;
comparing the input to the taptic pattern; and
authenticating a customer upon determining the input matches the taptic pattern.

13. The method of claim 12, further comprising:
encrypting the input into a 128 bit encrypted key for transmission by the remote authentication device;
receiving the 128 bit encrypted key; and
decrypting the 128 bit encrypted key to extract the input for comparison to the taptic pattern.

14. The method of claim 12, wherein the taptic pattern is divided into sequences and the customer provides each sequence of the recorded taptic pattern.

15. The method of claim 12, wherein the remote authentication device includes designated finger positions for each sequence of the recorded taptic pattern.

16. The method of claim 12, further comprising:
recording first biometric data from the customer when registering the customer; and
storing the first biometric data in the identity access management database,
migrating information from various data sources that can provide customer information including old or canceled accounts, and storing the migrated information in the identity access management database.

17. The method of claim 16, further comprising:
receiving second biometric data from the remote authentication device;
comparing the second biometric data to the first biometric data; and
authenticating the customer upon determining the second biometric data matches the first biometric data.

18. The method of claim 12, the authenticating comprising:
transmitting a verification response to the remote authentication device when the second taptic pattern matches the first taptic pattern.

19. A non-transitory computer readable medium having instructions to control a processor and a memory, comprising:
receiving a first taptic pattern from a remote authentication device;
comparing the first taptic pattern to a second taptic pattern stored in an identity access management database;
determining the first taptic pattern matches the second taptic pattern; and
authenticating a customer upon determining the first taptic pattern matches the second taptic pattern, wherein if the first taptic pattern varies from the stored taptic pattern by less than a preset threshold, the customer is still authenticated,
wherein if the first taptic pattern does not match the second taptic pattern the remote authentication device is prompted to reenter.

20. The non-transitory computer readable medium of claim 19, further comprising:
receiving a first biometric from the remote authentication device;
comparing the first biometric to a second biometric stored in an identity access management database;
determining the first biometric matches the second biometric; and authenticating the customer upon determining the first biometric matches the second biometric.
